(19) United States
(12) Patent Application Publication
(10) Pub. No.: US 2026/0210421 A1
(43) Pub. Date: Jul. 23, 2026

(54) TUNED MASS DAMPER HAVING MULTI-DEGREES OF FREEDOM

(71) Applicant: HD HYUNDAI ELECTRIC CO., LTD., Seongnam-si (KR)

(72) Inventor: Hyun Yong PARK, Seongnam-si (KR)

(21) Appl. No.: 19/274,893

(22) Filed: Jul. 21, 2025

(30) Foreign Application Priority Data
Jan. 17, 2025 (KR) 10-2025-0007387

(51) Int. Cl. F16F 7/104

(52) U.S. Cl. CPC F16F 7/104; F16F 2222/08; F16F 2230/0041; F16F 2232/08; F16F 2238/026

(57) ABSTRACT

Provided is a tuned mass damper having multiple degrees of freedom installed in a device that generates vibrations to reduce vibrations and noise. For a rotating machine or other object that generates resonance during operation, the vibration and natural frequency of the object are measured before shipment, and a tuned mass damper having multiple degrees of freedom is designed and installed to target frequencies (operating frequency and multiple resonant frequencies) at which high vibrations are induced, thereby obtaining the effect of reducing vibrations and noise.

### BACKGROUND

### Field

The present disclosure relates to a tuned mass damper having multiple degrees of freedom, installed in a device in which vibration is generated to reduce vibrations and noise.

### Description of Related Art

Recently, when the dynamic characteristics change when connecting the motor and the load, the natural frequency of the system matches the operating frequency, so that resonance occurs. To control this, a one-degree-of-freedom tuned mass damper is installed to reduce vibrations and noise.

In the related art, when the operating range is changed to a tuned mass damper for a single frequency, or when resonance occurs at two or more different frequencies, a separate tuned mass damper is installed to reduce vibrations and noise.

In detail, tuned mass dampers for motors have a problem in that they have little vibration reduction effect in the high-frequency range because they use rubber. If the tuned mass damper is ineffective after a single design, redesign and remanufacturing are required, so a solution is required to solve this.

### SUMMARY

An aspect of the present disclosure is to provide a novel type of tuned mass damper having multiple degrees of freedom, which may react to a first degree of freedom under normal driving conditions and may react to multiple degrees of freedom through manual adjustment under variable driving or in sections in which vibrations increase.

According to an aspect of the present disclosure, a tuned mass damper having multiple degrees of freedom includes a base plate; a plurality of first dampers provided on an upper surface of the base plate; a first weight plate mounted on upper portions of the plurality of first dampers; a plurality of second dampers provided on an upper surface of the first weight plate; a second weight plate mounted on upper portions of the plurality of second dampers; a plurality of first elastic members penetrating through the first weight plate and connecting the upper surface of the base plate and a lower surface of the second weight plate; at least one second elastic member provided between the base plate and the first weight plate; and a plurality of supports provided on a side surface of the base plate to be connected to at least the base plate among the base plate, the first weight plate, and the second weight plate.

In at least one embodiment, the plurality of supports may include a pair of first supports provided on both sides of the base plate, the first weight plate, and the second weight plate; and a pair of second supports orthogonal to the pair of first supports and provided on both sides of the base plate, the first weight plate, and the second weight plate.

In at least one embodiment, the pair of first supports may include a plurality of first fixing portions spaced apart from each other in a longitudinal direction.

In at least one embodiment, the plurality of first fixing portions may include a first bolt fastened to a side surface of the base plate; a second bolt fastened to a side surface of the first weight plate; and a third bolt fastened to a side surface of the second weight plate.

In at least one embodiment, the pair of second supports may include a plurality of second fixing portions spaced apart from each other in a longitudinal direction.

In at least one embodiment, the plurality of second fixing portions may include a fourth bolt fastened to a side surface of the base plate; a fifth bolt fastened to a side surface of the first weight plate; and a sixth bolt fastened to a side surface of the second weight plate.

In at least one embodiment, the tuned mass damper having multiple degrees of freedom may further include a cross support bar connecting one ends of the pair of first supports and one ends of the pair of second supports to each other.

In at least one embodiment, the base plate may further include a first post fixing one ends of the plurality of first elastic members to the upper surface, and the second weight plate may further include a second post fixing the other ends of the plurality of first elastic members to the lower surface.

In at least one embodiment, the first weight plate may further include a first weight provided on the upper surface, and the second weight plate further may include a second weight provided on the upper surface.

In at least one embodiment, the base plate, the first weight plate, the second weight plate, the first weight, and the second weight may be formed of metal, and the plurality of first dampers and the plurality of second dampers may be formed of silicone.

In at least one embodiment, the plurality of first elastic members may be tension springs, and the at least one second elastic member may be a compression spring.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a drawing illustrating a tuned mass damper having multiple degrees of freedom according to at least one embodiment;

FIG. 2 is a drawing illustrating an exploded view of a tuned mass damper having multiple degrees of freedom according to at least one embodiment;

FIG. 3 is a drawing illustrating a process of fixing a base plate, a first weight plate, and a second weight plate to a support so that a tuned mass damper having multiple degrees of freedom according to at least one embodiment may act as a mass body;

FIG. 4 is a drawing illustrating a process of fixing a base plate and a first weight plate to a support so that a tuned mass damper having multiple degrees of freedom according to at least one embodiment may act as a first-degree-of-freedom tuned mass damper; and

FIG. 5 is a drawing illustrating a process of fixing a base plate and a second weight plate to a support so that a tuned mass damper having multiple degrees of freedom according to at least one embodiment may act as a first-degree-of-freedom tuned mass damper.

### DETAILED DESCRIPTION

Hereinafter, the present disclosure will be described in detail through example drawings. When adding reference numerals to components in respective drawings, it should be noted that the same components are given the same numerals as much as possible even if they are illustrated in different drawings.

In this specification, the terms first, second, etc. may be used to describe various components, but these components are not limited in terms of order, size, location, or importance by the terms first, second, etc., and are named only for the purpose of distinguishing one component from another.

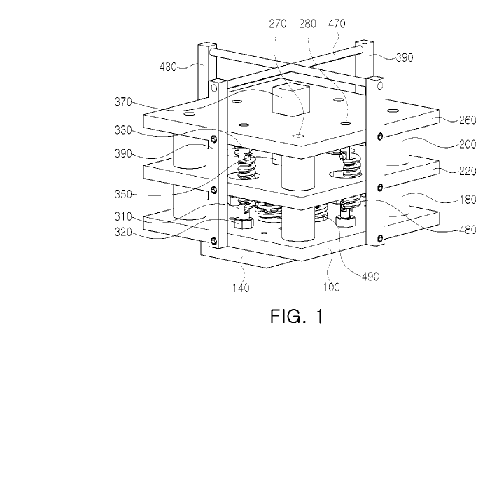

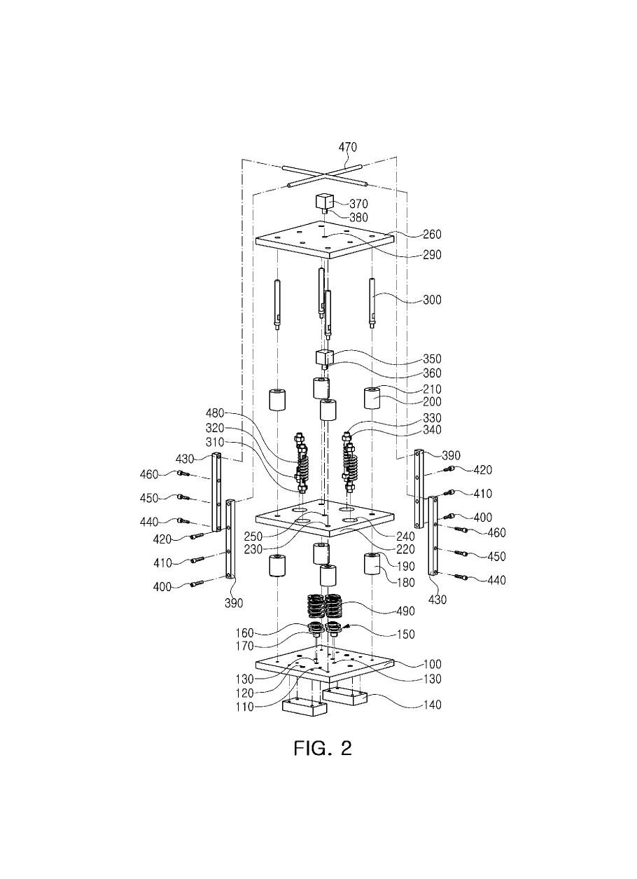

FIG. 1 is a drawing illustrating a tuned mass damper having multiple degrees of freedom according to at least one embodiment, and FIG. 2 is a drawing illustrating an exploded view of a tuned mass damper having multiple degrees of freedom according to at least one embodiment.

The tuned mass damper having multiple degrees of freedom according to at least one embodiment is installed on a vibrating body that generates vibration to reduce vibrations and noise.

The vibrating body may include anything that generates vibration, and the vibrating body may be a rotating machine.

In the present embodiment, the rotating machine may be, for example, an electric motor.

Referring to FIG. 1 and FIG. 2, the tuned mass damper having multiple degrees of freedom in the present embodiment includes a base plate 100, a first damper, a first weight plate 220, a second damper 200, a second weight plate 260, a first elastic member, a second elastic member, and a plurality of supports.

The base plate 100 has a quadrangular plate shape.

The base plate 100 is formed with a plurality of first damper holes 110 and first post holes 120 so that the first damper and the first post 310 to be described later are installed.

The first damper hole 110 is formed on the corner side of the base plate 100.

Since the base plate 100 has four corners, the first damper holes 110 are formed on the four corners, respectively.

The base plate 100 is formed with a plurality of elastic member mounting portions 150 at the center of the upper surface.

The elastic member mounting portions 150 are four in this embodiment, and may be disposed in a cross shape at the center of the base plate 100.

The elastic member mounting portions 150 are formed with a spring coupling portion 160 at the upper portion thereof and a protrusion 170 at the lower portion thereof.

The elastic member mounting portion 150 is provided in such a manner that the protrusion 170 is connected to the mounting hole 130 formed in the base plate 100.

The base plate 100 is provided with at least one connection portion 140 that is installed on the lower surface thereof and connects a tuned mass damper having multiple degrees of freedom to a vibrating body.

The first damper is provided in plural in multiple first damper holes 110 formed in the upper surface of the base plate 100.

In detail, four first dampers are positioned in the first damper holes 110, to be positioned on the four corners of the base plate 100, respectively.

The first damper has a cylindrical shape, and has a first coupling hole 190 formed in the axial direction.

The first damper may be formed of silicone in the present embodiment.

According to an embodiment, the first damper may be formed of rubber instead of silicone.

The first damper may be coupled to the base plate 100 by a bolt 300 together with the first weight plate 220, the second damper 200, and the second weight plate 260 to be described later.

The first weight plate 220 is provided such that corners thereof are mounted on the upper portions of the four first dampers described above.

The first weight plate 220 has a quadrangular plate shape with the same size as the base plate 100 and may also have the same thickness as that of the base plate 100. Therefore, the first weight plate 220 may have the same weight as the weight of the base plate 100.

In the first weight plate 220, a second damper hole 230 is formed in the same position as the first damper hole 110 formed in the base plate 100, for example, in the position corresponding thereto.

In addition, in the first weight plate 220, a through-hole 240 having a greater diameter than a diameter of the first post hole 120 is formed in the same position as the first post hole 120 of the base plate 100, for example, in the position corresponding thereto.

The diameter of the through-hole 240 may be formed greater than the diameter of the first elastic member described later.

The second damper 200 is provided in plural in the second damper hole 230 formed in the upper surface of the first weight plate 220.

In detail, four second dampers 200 are coupled to the second damper holes 230, and thus are positioned in the four corners of the base plate 100, respectively.

The second damper 200 has a cylindrical shape and has a second coupling hole 210 formed in the axial direction.

The second damper 200 may be formed of silicone in this embodiment.

Depending on an embodiment, the second damper 200 may be formed of rubber instead of silicone.

The second weight plate 260 is provided such that four corners thereof are mounted on the upper portions of the second damper 200.

The second weight plate 260 has a quadrangular plate shape with the same size as the base plate 100 and may also have the same thickness as the base plate 100. Therefore, the second weight plate 260 may have the same weight as the weight of the first weight plate 220 and the base plate 100.

The second weight plate 260 has a third damper hole 270 formed therein to be coupled to the upper portion of the second damper 200 described later.

The base plate 100, the first damper, the first weight plate 220, the second damper 200, and the second weight plate 260 are coupled by one bolt 300 sequentially passing through the third damper hole 270, the second coupling hole 210, the second damper hole 230, and the first coupling hole 190 in order, and the end of the bolt 300 is coupled to the first damper hole 110.

The second weight plate 260 has a plurality of second post holes 280 formed in the same location as the first post holes 120 of the base plate 100, in detail, in the positions corresponding thereto, so that the second posts 330 to be described later are installed therein.

The first post 310 is installed on the lower surface of the second weight plate 260.

The first elastic member is provided in multiple numbers to connect the upper surface of the base plate 100 and the lower surface of the second weight plate 260, by penetrating through the through-holes 240 formed in the first weight plate 220.

In this embodiment, one first elastic member is respectively provided between the corners.

At least one second elastic member is provided between the base plate 100 and the first weight plate 220. In this embodiment, four second elastic members are disposed in a cross shape in the center of the base plate 100 to provide elastic force to separate the base plate 100 and the first weight plate 220.

The plurality of supports selectively fix the base plate 100, the first weight plate 220, and the second weight plate 260.

The plurality of supports include a pair of first supports 390 and a pair of second supports 430.

A pair of first supports 390 are provided on both sides of the base plate 100, the first weight plate 220, and the second weight plate 260.

A pair of first supports 390 are formed with a plurality of first fixing portions that are formed spaced apart in the longitudinal direction.

The plurality of first fixing portions include a plurality of bolt holes 461, and a first bolt 400, a second bolt 410, and a third bolt 420 that are inserted into the plurality of bolt holes 461, respectively.

The first bolt serve to fix the first support 390 to the side surface of the base plate 100.

The second bolt 410 serves to fix the first support 390 to the side surface of the first weight plate 220.

The third bolt 420 serves to fix the first support 390 to the side surface of the second weight plate 260.

A pair of second supports 430 are installed on the base plate 100, the first weight plate 220, and the second weight plate 260, and are provided on both sides thereof to be orthogonal to the pair of first supports 390.

A pair of second supports 430 are formed with a plurality of second fixing portions spaced apart in the longitudinal direction.

The plurality of second fixing portions include a plurality of bolt holes 461, and a fourth bolt 440, a fifth bolt 450, and a sixth bolt 460 inserted into the plurality of bolt holes 461, respectively.

The fourth bolt 440 serves to secure the second support 430 to the side surface of the base plate 100.

The fifth bolt 450 serves to secure the second support 430 to the side surface of the first weight plate 220.

The sixth bolt 460 serves to secure the second support 430 to the side surface of the second weight plate 260.

The tuned mass damper having multiple degrees of freedom according to an embodiment further includes a cross support bar 470 connecting one ends of a pair of first supports 390 and a pair of second supports 430 to each other so that they become one piece.

The base plate 100 further includes a first post 310 that secures one end of the first elastic member to the upper surface thereof.

The second weight plate 260 further includes a second post 330 that secures the other end of the first elastic member to the lower surface thereof.

The first post 310 and the second post 330 include a first adjustment bolt 320 and a second adjustment bolt 340 to enable length adjustment, respectively.

The first post 310 and the second post 330 may be provided to be in a preload state on the first elastic member through length adjustment.

The first weight plate 220 may be provided with a first weight 350 on the upper surface.

The second weight plate 260 may be provided with a second weight 370 on the upper surface.

The first weight 350 and the second weight 370 may be in the shape of a rectangular parallelepiped in this embodiment, and a first fastening bolt 360 and a second fastening bolt 380 may be formed on one surfaces of the rectangular solids, respectively, for easy coupling, and may be coupled to the first fastening hole 250 and the second fastening hole 290 of the first weight plate 220 and the second weight plate 260, respectively.

According to an embodiment, the first weight 350 and the second weight 370 may be in the shape of a cylinder.

The first weight 350 and the second weight 370 may be manufactured in plural in various sizes so that they may be replaced according to the measured natural frequency.

The first elastic member may be a tension spring 480.

The second elastic member may be a compression spring 490. In addition, the compression spring 490 may be formed to have a greater diameter than the diameter of the tension spring 480.

The base plate 100, the first weight plate 220, the second weight plate 260, the first weight 350 and the second weight 370 may be formed of a metal material.

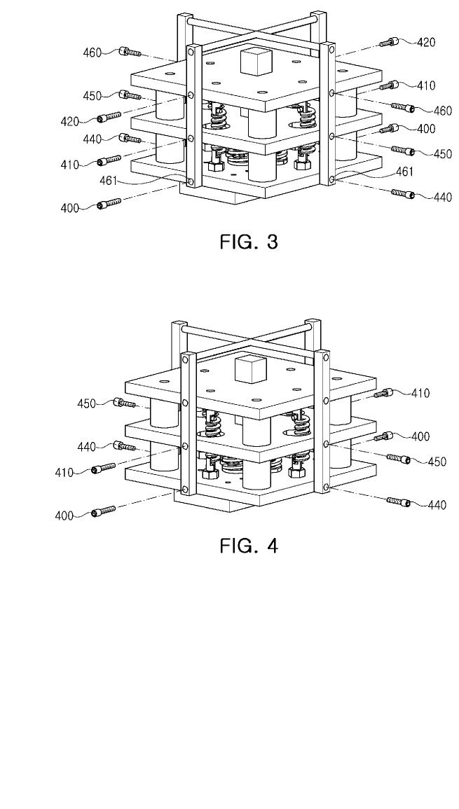

Next, referring to FIGS. 3 to 5, a process of selectively fixing the first weight plate 220 and the second weight plate 260 to the base plate 100 so that the tuned mass damper having multiple degrees of freedom becomes a mass body, a first-degree-of-freedom tuned mass damper or a second-degree-of-freedom tuned mass damper is described.

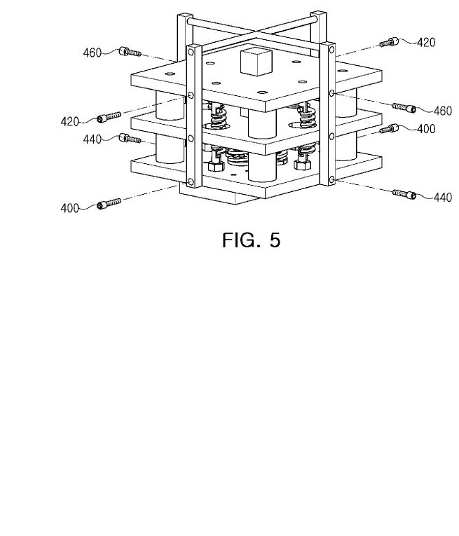

FIG. 3 is a drawing illustrating a process of fixing a base plate 100, a first weight plate 220, and a second weight plate 260 to a support so that a tuned mass damper having multiple degrees of freedom according to at least one embodiment performs the role of a mass body, FIG. 4 is a drawing illustrating a process of fixing a base plate 100 and a first weight plate 220 to a support so that a tuned mass damper having multiple degrees of freedom according to at least one embodiment performs the role of a first-degree-of-freedom tuned mass damper, and FIG. 5 is a drawing illustrating a process of fixing a base plate 100 and a second weight plate 260 to a support so that a tuned mass damper having multiple degrees of freedom according to at least one embodiment performs the role of a first-degree-of-freedom tuned mass damper.

To set the tuned mass damper having multiple degrees of freedom to act as a mass, as illustrated in FIG. 3, the base plate 100 is fixed with the first bolt 400 formed on a pair of first supports 390, the first weight plate 220 is fixed with the second bolt 410, and the second weight plate 260 is fixed with the third bolt 420.

In addition, to strengthen the fixing force, the base plate 100 is fixed with the fourth bolt 440 formed on a pair of second supports 430, the first weight plate 220 is fixed with the fifth bolt 450, and the second weight plate 260 is fixed with the sixth bolt 460.

Therefore, the base plate 100, the first weight plate 220, and the second weight plate 260 are fixed, and when the base plate 100 vibrates, the first weight plate 220 and the second weight plate 260 also vibrate in the same manner, so that the tuned mass damper having multiple degrees of freedom may act as a mass.

Next, to set the tuned mass damper having multiple degrees of freedom to act as a first-degree-of-freedom tuned mass damper, as illustrated in FIG. 4, the base plate 100 is fixed with the first bolt 400 formed on a pair of first supports 390, and the first weight plate 220 is fixed with the second bolt 410. In this case, the third bolt 420 does not fix the second weight plate 260.

In addition, to strengthen the fixing force, the base plate 100 is fixed with the fourth bolt 440 formed on a pair of second supports 430, and the first weight plate 220 is fixed with the fifth bolt 450. In this case, the sixth bolt 460 does not fix the second weight plate 260.

Therefore, since the base plate 100 and the first weight plate 220 are fixed, the tuned mass damper having multiple degrees of freedom may perform the role of the first-degree-of-freedom tuned mass damper. The first-degree-of-freedom tuned mass damper is obvious to those with ordinary knowledge, and thus a detailed description is omitted.

As a result, to set the tuned mass damper having multiple degrees of freedom to function as a second-degree-of-freedom tuned mass damper, as illustrated in FIG. 5, the base plate 100 is fixed with the first bolt 400 formed on a pair of first supports 390, and the second weight plate 260 is fixed with the third bolt 420. In this case, the second bolt 410 does not fix the first weight plate 220.

In addition, to strengthen the fixing force, the base plate 100 is fixed with the fourth bolt 440 formed on a pair of second supports 430, and the second weight plate 260 is fixed with the sixth bolt 460. In this case, the fifth bolt 450 does not fix the first weight plate 220.

Therefore, since the base plate 100 and the second weight plate 260 are fixed, the tuned mass damper having multiple degrees of freedom may function as a second-degree-of-freedom tuned mass damper. Since the second-degree-of-freedom tuned mass damper is obvious to those of ordinary skill in the art, a detailed description thereof is omitted.

As set forth above, according to an embodiment, for a rotating machine or other object that generates resonance during operation, the vibration and natural frequency of the object are measured before shipment, and a tuned mass damper having multiple degrees of freedom is designed and installed to target frequencies (operating frequency and multiple resonant frequencies) at which high vibrations are induced, thereby obtaining the effect of reducing vibrations and noise.

The above-described and illustrated embodiments of the present disclosure may be combined with each other, and each embodiment may optionally adopt or replace some components of other embodiments as needed.

While example embodiments have been illustrated and described above, it will be apparent to those skilled in the art that modifications and variations could be made without departing from the scope of the present disclosure as defined by the appended claims.

What is claimed is:

1. A tuned mass damper having multiple degrees of freedom, comprising:
a base plate;
a plurality of first dampers provided on an upper surface of the base plate;
a first weight plate mounted on upper portions of the plurality of first dampers;
a plurality of second dampers provided on an upper surface of the first weight plate;
a second weight plate mounted on upper portions of the plurality of second dampers;
a plurality of first elastic members penetrating through the first weight plate and connecting the upper surface of the base plate and a lower surface of the second weight plate;
at least one second elastic member provided between the base plate and the first weight plate; and
a plurality of supports provided on a side surface of the base plate to be connected to at least the base plate among the base plate, the first weight plate, and the second weight plate.

2. The tuned mass damper of claim 1, wherein the plurality of supports include,
a pair of first supports provided on both sides of the base plate, the first weight plate, and the second weight plate; and
a pair of second supports orthogonal to the pair of first supports and provided on both sides of the base plate, the first weight plate, and the second weight plate.

3. The tuned mass damper of claim 2, wherein the pair of first supports include a plurality of first fixing portions spaced apart from each other in a longitudinal direction.

4. The tuned mass damper of claim 3, wherein the plurality of first fixing portions include,
a first bolt fastened to a side surface of the base plate;
a second bolt fastened to a side surface of the first weight plate; and
a third bolt fastened to a side surface of the second weight plate.

5. The tuned mass damper of claim 2, wherein the pair of second supports include a plurality of second fixing portions spaced apart from each other in a longitudinal direction.

6. The tuned mass damper of claim 5, wherein the plurality of second fixing portions include,
a fourth bolt fastened to a side surface of the base plate;
a fifth bolt fastened to a side surface of the first weight plate; and
a sixth bolt fastened to a side surface of the second weight plate.

7. The tuned mass damper of claim 2, further comprising a cross support bar connecting one ends of the pair of first supports and one ends of the pair of second supports to each other.

8. The tuned mass damper of claim 1, wherein the base plate further includes a first post fixing one ends of the plurality of first elastic members to the upper surface, and
the second weight plate further includes a second post fixing the other ends of the plurality of first elastic members to the lower surface.

9. The tuned mass damper of claim 1, wherein the first weight plate further includes a first weight provided on the upper surface, and
the second weight plate further includes a second weight provided on the upper surface.

10. The tuned mass damper of claim 9, wherein the base plate, the first weight plate, the second weight plate, the first weight, and the second weight are formed of metal, and
the plurality of first dampers and the plurality of second dampers are formed of silicone.

11. The tuned mass damper of claim 1, wherein the plurality of first elastic members are tension springs, and
the at least one second elastic member is a compression spring.
